(19) United States
(12) Patent Application Publication
(10) Pub. No.: US 2020/0327473 A1
(43) Pub. Date: Oct. 15, 2020

(54) METHODS AND SYSTEMS FOR BRIDGING PAIRWISE COMMUNICATION IN A NETWORK OF DISPARATE ENTERPRISE SYSTEMS

(71) Applicant: EYGS LLP, London (GB)

(72) Inventors: Chen ZUR, Tenafly, NJ (US); Mathew HARROWING, Roswell, GA (US); Tze Wan ANG, Weehawken, NJ (US); Kimmie LUETZHOEFT, Miami, FL (US); Robert John VAN SANT, Queens, NY (US); Jaya Prakash Narayana GUTTA, Cumming, GA (US)

(21) Appl. No.: 16/848,506

(22) Filed: Apr. 14, 2020

Related U.S. Application Data
(60) Provisional application No. 62/834,346, filed on Apr. 15, 2019.

(51) Int. Cl. G06Q 10/06; G06Q 10/08; G06Q 20/38; G06Q 40/02; H04L 9/32; H04L 9/06

(52) U.S. Cl. CPC G06Q 10/06315; G06Q 10/06312; G06Q 10/0833; H04L 2209/38; G06Q 40/02; H04L 9/3213; H04L 9/0643; G06Q 20/389

(57) ABSTRACT

Embodiments of the instant disclosure include methods and systems directed at multi-token representation of assets involved in transactions occurring on distributed-ledger based networks that bridge or facilitate such transactions between disparate enterprise resource planning (ERP) systems. The disclose methods and systems improve network performance by at least reducing inefficiencies or errors that occur when disparate systems transact.

### CROSS-REFERENCE TO RELATED PATENT APPLICATION

This application claims priority to and the benefit of U.S. Provisional Application No. 62/834,346, filed Apr. 15, 2019, entitled “Methods and Systems for Multi-Token Representation of Transactions on Distributed Ledger-Based Networks,” which is incorporated herein by reference in its entirety.

### FIELD OF THE DISCLOSURE

The instant disclosure illustrates bridging pairwise communication in a network of disparate and complex enterprise resource planning (ERP) systems to reduce network inefficiencies, communication or other errors that would otherwise burden the functions of the ERP systems. Methods and systems disclosing the use of a distributed ledger-based network (DLN) to improve the performances and communication of disparate ERP systems are presented herein.

### BACKGROUND

Organizations of different sizes use enterprise resource planning (ERP) systems to manage operations of their businesses and automate functions such as technology, services, human resources and/or the like. In some cases, in particular when the organizations are large, the organizations may use different ERP systems to manage the multiple parts of a company. Cross-company transactions as well as inter-company transactions may then lead to interactions between a network of disparate ERP systems and outputs thereof.

### BRIEF DESCRIPTION OF THE FIGURES

FIGS. 1A-B show a schematic block diagram (FIG. 1A) illustrating a distributed ledger-based network (DLN) system configured to facilitate inter- and/or cross-organizational transactions or communications, according to some embodiment. FIG. 1B shows an example schematic of a DLN.

FIG. 2 shows a schematic block diagram illustrating a DLN system configured to facilitate inter- and/or cross-organizational transactions or communications, according to another embodiment.

FIG. 3 shows a schematic block diagram illustrating a DLN to facilitate inter-and/or cross-organizational transactions or communications, according to an embodiment.

FIG. 4 shows a schematic flow chart illustrating an example application of the DLN system in executing a transaction, according to an embodiment.

FIG. 5 shows a schematic flow chart illustrating an example use of smart contracts and tokens in a DLN system to facilitate exchange of goods and payment during inter and/or cross-organizational transactions, according to an embodiment.

FIG. 6 shows a schematic flow chart illustrating an example use of smart contracts in a DLN system to facilitate the shifting of obligations during inter and/or cross-organizational transactions, according to an embodiment.

FIG. 7 shows a schematic flow chart illustrating an example use of smart contracts and tokens in a DLN system to facilitate execution of instruments of obligations during inter and/or cross-organizational transactions, according to an embodiment.

FIGS. 8A-D show a schematic flow chart (FIG. 8A) and schematic block diagrams (FIGS. 8B-8D) illustrating communication systems between enterprise resource planning systems of organizations and a DLN system during inter and/or cross-organizational transactions, according to an embodiment.

### SUMMARY OF THE DISCLOSURE

Some embodiments of the current disclosure disclose a method comprising bridging an enterprise resource planning (ERP) system of a buyer enterprise to an ERP system of a seller enterprise that is different from the ERP system of the buyer enterprise. In some implementations, the bridging includes receiving, at a compute node of a distributed-ledger based network (DLN) and from the ERP system of the buyer enterprise, a purchase order to purchase a product from the seller enterprise based on a purchase agreement between the buyer enterprise and the seller enterprise; extracting, via the compute node and from the purchase agreement, terms of the purchase agreement to trigger the ERP system of the seller enterprise to generate a sales order based on the extracted terms of the purchase agreement; and triggering, via the compute node, generation of an accounts payable invoice at the ERP system of the buyer enterprise and generation of an accounts receivable invoice at the ERP system of the seller enterprise in response to approval by the seller enterprise of the sales order and/or confirmation by the buyer enterprise of delivery of the product to the buyer enterprise. Further, the method comprises transferring, via the compute node and in response to the approval by the seller enterprise of the sales order, a token from a seller account on the DLN of the seller enterprise to a first account on the DLN, the token representing on the DLN an attribute of the product; and confirming, via the compute node, settlement of the purchase order after (1) the transferring of the token and/or the triggering of the generation of the accounts payable invoice and (2) the triggering of the generation of the accounts receivable invoice.

In some implementations, the token representing the attribute of the product is a token representing an ownership attribute of the product, and the first account is a buyer account on the DLN of the buyer enterprise. In some implementations, the token representing the attribute of the product is a token representing a physical location attribute of the product, and the first account is a shipper account on the DLN of an intermediate entity tasked with transporting the product to the buyer enterprise. In such implementations, the aforementioned method further comprises transferring, via the compute device, the token representing the physical location attribute of the product from the shipper account to a buyer account on the DLN of the buyer enterprise after the delivery of the product to the buyer enterprise.

In some implementations, the settlement of the purchase order is confirmed after a token representing payment for the product is transferred, via the compute node, from a buyer account on the DLN of the buyer enterprise to the seller account. In some implementations, the purchase order is not received at the ERP system of the seller enterprise. In some implementations, the sales order is generated automatically by the ERP system of the seller enterprise without an input from the seller enterprise, or an agent thereof. In some implementations, the accounts payable invoice is generated automatically at the ERP system of the buyer enterprise without an input from the buyer enterprise, or an agent thereof. In some implementations, the accounts receivable invoice is generated automatically at the ERP system of the seller enterprise without an input from the seller enterprise, or an agent thereof.

Some embodiments of the current disclosure disclose a method comprising bridging an enterprise resource planning (ERP) system of a parent enterprise to an ERP system of a subsidiary enterprise that is different from the ERP system of the parent enterprise. In some implementations, the bridging includes receiving, at a compute node of a distributed-ledger based network (DLN) and from the ERP system of the parent enterprise, an indication of incurrence of an expense by the parent enterprise to be allocated to the subsidiary enterprise; extracting, via the compute node and from a master services agreement governing allocation to the subsidiary enterprise of the expense incurred by the parent enterprise, terms and conditions of the master services agreement; and triggering, via the compute node, generation of: (1) an accounts receivable invoice at the ERP system of the parent enterprise; and (2) an accounts payable invoice at the ERP system of the subsidiary enterprise indicating a portion of the expense to be allocated to the subsidiary enterprise. In some implementations, the triggering can be caused by a self-executing code segment executing on the DLN and generated based on the terms and conditions of the master services agreement. The method further comprises generating, via the compute node, a confirmation confirming allocation of the portion of the expense to the subsidiary enterprise after the triggering of the generation of the accounts payable invoice and the accounts receivable invoice.

In some implementations, the generation of the accounts payable invoice occurs after the self-executing code segment is approved by the subsidiary enterprise. In some implementations, the accounts payable invoice is generated automatically at the ERP system of the subsidiary enterprise without an input from the subsidiary enterprise, or an agent thereof. In some implementations, the accounts receivable invoice is generated automatically at the ERP system of the parent enterprise without an input from the parent enterprise, or an agent thereof.

Some embodiments of the current disclosure disclose a method comprising bridging an enterprise resource planning (ERP) system of a lender enterprise to an ERP system of a borrower enterprise that is different from the ERP system of the lender enterprise. The bridging includes receiving, at a compute node of a distributed-ledger based network (DLN) and from the ERP system of the lender enterprise, an indication of a loan to be provided by the lender enterprise to the borrower enterprise based on a loan agreement between the lender enterprise and the borrower enterprise; extracting, via the compute node and from the loan agreement, terms and conditions of the loan agreement; and receiving, at the compute node and from the ERP system of the borrower enterprise, approval of the extracted terms and conditions of the loan agreement. The method also includes generating, via the compute node and based on the extracted terms and conditions of the loan agreement, a self-executing code segment to be executed on the DLN, the self-executing code segment configured to: (1) generate a token representing ownership attribute of the loan on the DLN; and (2) deposit the token into a lender account on the DLN of the lender enterprise; and generating, via the compute node and in response to the deposit of the token into the lender account, a confirmation confirming disbursement of the loan from the lender enterprise to the borrower enterprise. In some implementations, the self-executing code segment is further configured to annul the token in response to an indication that the lender enterprise no longer owns the loan.

In some implementations, the token representing the ownership attribute of the loan is a first token, and the self-executing code segment is further configured to transfer a second token representing an amount of the loan from the lender account on the DLN of the lender enterprise to a borrower account on the DLN of the borrower enterprise. In some implementations, the transferring of the second token occurs without an input from the lender enterprise.

In some implementations, the self-executing code segment is further configured to transfer a second token representing an amount of interest to be paid on the loan from the borrower account on the DLN of the borrower enterprise to the lender account on the DLN of the lender enterprise. In some implementations, the transferring of the second token occurs without an input from the lender enterprise or the borrower enterprise

### DETAILED DESCRIPTION

Organizations of different sizes use so-called enterprise resource planning (ERP) systems to manage operations and resources of their businesses and automate various functions of the organization. Some organizations, in particular large ones, tend to use different types of ERP systems; that is, they have a large network of disparate ERP systems interacting and communicating amongst themselves because of the varied needs of a large organization and/or legacy systems that remained after mergers or acquisitions. As such, when different units of a large organization or company transact among each other or with the large organization itself via their separate ERP systems and/or organizations that use different ERP systems transact with each other, inefficiencies may result due to the disparateness of the ERP systems. That is, due to the disparateness of the ERP systems that make up the network of ERP systems (of the same or different organizations), the network may suffer inefficiencies in its performance (e.g., communication between the constituent ERP systems, etc.). For example, the different ERP systems may employ different processes, messaging systems, so-called item master data, input fields, output fields, etc., and produce, during transactions or communications, inconsistent outputs that may have to be reconciled later (e.g., manually), resulting in increased transaction cost and inefficiencies for the network of ERP systems as well as possible regulatory non-compliance and legal risks (e.g., incorrect regulatory filings, etc.).

In some embodiments, methods and systems to bridge pairwise inter- and/or cross-organizational transactions or communications between ERP systems of a network of ERP systems based on distributed ledger-based or blockchain technology are disclosed. As noted above, the network of ERP systems may include ERP systems that belong to the same organization or different organizations. Some or all of the ERP systems may, however, be different from each other, resulting in network inefficiencies and performance degradations when the ERP systems transact or communicate with each other. The methods and systems allow for pairwise bridging of the constituent ERP systems of the network to reduce or even eliminate said network inefficiencies and performance degradations. For instance, the methods and systems disclose the use of a distributed ledger-based network (DLN) to bridge transacting or communicating ERP systems of the network of ERP systems to reduce or eliminate inefficiencies that would exist without the use of the DLN.

As an example illustration, a pair of constituent units of a large organization or a constituent unit of the large organization and the large organization itself may be engaged in a transaction with each other involving the sale of an asset via their respective ERP systems (of the network of ERP systems including the ERP systems of other non-transacting parties). In such cases, the methods and systems disclose the use of a DLN to bridge the constituent ERP systems of the network of ERP systems of the large organization and its constituent units, thereby facilitating the transaction (and related communication between ERP systems) and reducing or eliminating inefficiencies that can occur without the use of the DLN, such as but not limited to delayed or failed reconciliation of transaction, need for manual execution of the transaction, inaccurate record keeping, etc. For example, the ERP systems of the pair of constituent units may be disparate, i.e., among other things, may have different transaction execution processes, messaging systems, databases, input fields, output fields, transaction recording and reporting systems, etc. In such cases, without the bridging of the ERP systems by the DLN, the transaction between the ERP systems of the constituent units may require manual intervention, leading to the afore-mentioned inefficiencies. The use of the DLN to bridge the ERP systems as discussed throughout the instant specification may, however, facilitate the transaction, thereby improving the efficiencies and functions of the network of ERP systems.

In some implementations, the methods and systems allow for the representation on the DLN of multiple facets of the asset through tokenization to facilitate the automatic reconciliation of the transaction, transfer pricing and/or enhanced intercompany transaction recording and management. For example, tokens can represent on the DLN the physical asset, attributes of the asset such as the custodian of the asset and legal ownership with options to provide payment tokens to facilitate settlement. The ownership token can also be used to support revenue recognition by having costs and revenue recognized simultaneously. Further, tokens can also be used to represent services and so accounting can also be automated through the application of smart contracts. Thus, with facets of assets and services represented using multiple tokens, complex revenue recognition and lease accounting may be automated. Furthermore, the disclosed methods and systems of bridging ERP systems via a DLN facilitate the recording of the movement of actual assets (instead of or in addition to the classification of an asset class). As such, the bridging of ERP systems via a DLN including the tokenization of assets that are part of the transaction being executed between the ERP systems allows one to record and track the movement of actual assets across complex enterprise resource planning (ERP) systems and supply chain environments, and to facilitate the transfer of the same asset across multiple parties.

In some implementations, each asset, represented by tokens on the DLN, i.e., blockchain network, may store pricing logic such as but not limited to whether the asset is sold as “resale minus”, “standard cost” or “cost plus”. In some implementations, the cost of goods sold (COGS), price, mark-up, margin for principle entities, and/or etc., can be stored in databases (e.g., SwarmDB) and can be used for transfer pricing documentation and reporting. Dynamic pricing rules may be available for each of the participating nodes whereby suggested prices can take into account if a legal entity is over or under planned margin. Disputes may be managed through the application of the distributed ledger-based networks.

The systems disclosed herein can be used as stand-alone or integrated with ERPs and/or other incumbent systems to facilitate intercompany/cross-company (i.e., inter- and/or cross-organizational) transactions, communications and reconciliation for consolidation purposes in near real time basis. The DLN or blockchain network (e.g., intercompany blockchain network) may act as a DLN for intercompany transactions, which may provide a “single source of truth”, automated matching and reconciliations of intercompany transactions, while simultaneously providing an immutable or nearly immutable audit trail. As such, there may not be a single database with matching rules to facilitate reconciliations of outputs of disparate ERP systems by bringing the disparate ERP systems of a transaction into the single database. Rather, transactions in the DLN or blockchain can be captured in “smart contracts,” which can encode business and control logic to allow automatic verification and processing. As such, a DLN may be integrated into the ERP systems of different transacting organizations, which allows for the recording of at least substantially same or similar details within the DLN (e.g., by the different ERP systems). Further, the use of a DLN allows one to track the asset across multiple ERP environments, facilitating the building of data supporting the asset creation and value. The methods and systems disclosed herein may allow supply-chain transactions to be automated and may provide visibility across disparate systems. Further, inter-organizational and/or cross-organizational transactions may be reconciled and/or settled automatically. In addition, transactional data may be obtained and reported in real-time or near real-time.

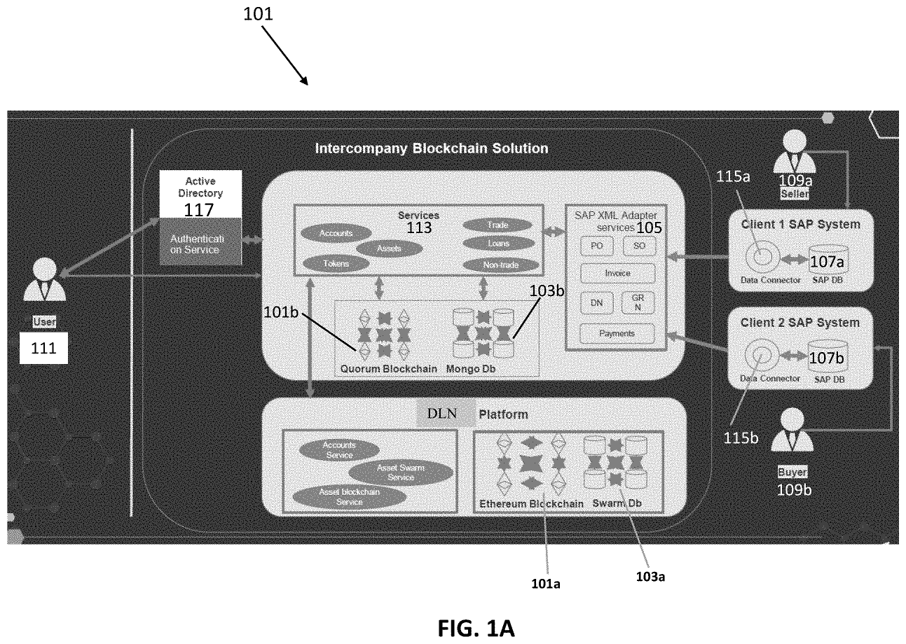

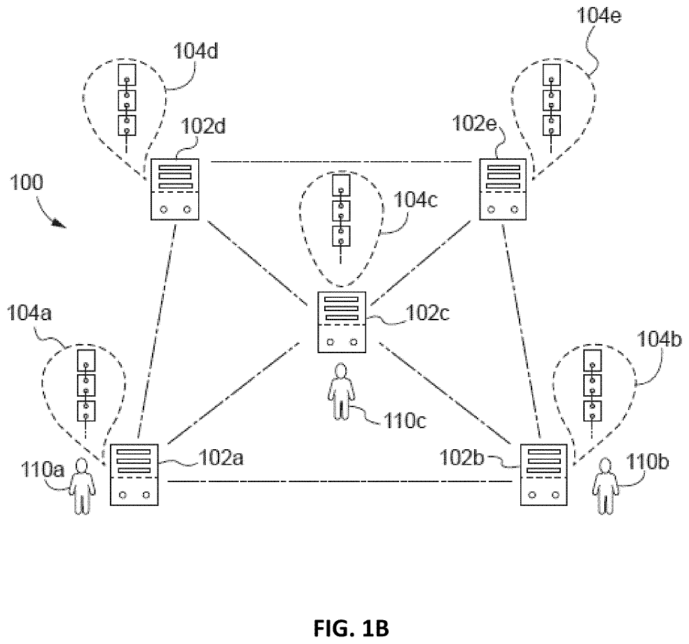

FIG. 1A shows a schematic block diagram illustrating a DLN system configured to facilitate inter and/or cross-organizational transactions involving organizational management systems, according to some embodiments. In some implementations, the DLN system 101 may include one or more DLNs 101a, 101b (e.g., a Ethereum blockchain, a Quorum blockchain, etc.) coupled to one or more databases 103a, 103b (e.g., a Swarm database configured according to the Ethereum storage protocol, a Mongo database configured according to the Quorum storage protocol, etc.). In some implementations, the DLN system 101 may also include an ERP adapter 105 that is configured to facilitate or streamline interactions between ERP systems 107a, 107b of clients 109a, 109b that use a transaction system (not shown) having the DLN system 100 to transact among each other and/or an external customer 111 (e.g., customer 111 accessing the transaction system via an authentication service 117 which may include, without limitations, an active directory). For example, the ERP adapter 105 may facilitate or streamline interactions by processing (e.g., receiving, sending, etc.) purchase orders (POs), sales orders (SOs), invoices, goods received notes (GRNs), delivery notes (DNs), payments, and/or the like that are part of transactions among the clients 107a, 107b and customer 111. In some implementations, the transactions may include services 113, such transactions including trade transactions (e.g., transactions involving the sale/movement of inventory and payments), non-trade transactions (e.g., transactions not involving the sale/movement of inventory and payments such as but not limited to transactions between different units of the same organization reallocating obligations), loan transactions (e.g., transactions involving the lending or borrowing of money (e.g., between different units of the same organization)), and/or the like. In some implementations, a transaction system having the DLN system 101 allows the use of services 113 that include the use of features such as but not limited to tokens, smart contracts, accounts, etc., when conducting a transaction using the transaction system having the DLN system 101. In some implementations, the ERP systems 107a, 107b (e.g., SAP ERP systems) may include ERP databases (e.g., SAP database) and/or data connectors 115a, 115b configured to relay data between the ERP system or components thereof (e.g., ERP database) and the ERP adapter 105.

In some embodiments, as noted above, the DLN system 101 may include one or more DLNs 101a, 101b (e.g., a Ethereum blockchain, a Quorum blockchain, etc.). In some implementations, a DLN 101a, 101b can be and/or support a blockchain. In some embodiments, the terms “distributed ledger-based network” and “blockchain network” may be used interchangeably. Similarly, in some embodiments, the terms “self-executing code” or “self-executing code segment” and “smart contract” may be used interchangeably. Further, in some embodiments, the term “transaction” may be used to refer to off-chain transactions (e.g., transactions involving the sale of physical or digital assets between parties) and/or on-chain representation of these off-chain transactions (e.g., the transaction of tokens that represent the assets on the blockchain network). Whether the term refers to the former or the latter case should be clear from context. In some embodiments, the term “transaction” may also be used to refer to transactions that occur on the DLN (e.g., transfer of tokens such as but not limited to cryptocurrency between accounts on the DLN). In some embodiments, the terms “off-chain” or “off-the DLN” are to be understood to refer to states or actions that are not occurring “on the blockchain network” or “on the DLN.” For example, a statement such as “the data is stored off-the DLN” is to be understood to refer to the state of “the data not being stored on the storage system(s) of, or not being controlled by, the DLN (and is instead stored at or controlled by systems elsewhere, i.e., on a storage system that is not on the DLN).”

In some embodiments, as noted above, a transaction system having the DLN system 101 allows the use of services 113 such as but not limited to tokens, assets, accounts, etc., when conducting a transaction using the transaction system having the DLN system 101. In some implementations, a DLN system 101 includes blockchain networks 101a, 101b (hereinafter referred simply as “DLNs”). An example schematic illustration of the DLNs or blockchain networks 101a, 101b is shown in FIG. 1B, which includes multiple compute nodes 102a-102e configured to communicate amongst each other via a peer-to-peer (P2P) connection. In some implementations, the compute nodes 102a-102e can each be computing devices including but not limited to a computer, server, processor, data/information processing machine or system, and/or the like, and include a data storage system such as a database, memory (volatile and/or non-volatile), etc. In some implementations, the P2P connections may be provided by wired and/or wireless communications systems or networks (not shown) such as but not limited to the internet, intranet, local area networks (LANs), wide area networks (WANs), etc., using wireless communication protocols or standards such as WiFi®, LTE®, WiMAX®, and/or the like.

In some embodiments, the DLN 100 may include self-executing codes or smart contracts that are configured to execute upon fulfillment of conditions that are agreed upon between transacting parties. For example, some or all of the compute nodes 102a-102e may include copies of a self-executing code that self-execute upon fulfillment of the conditions. In some implementations, the compute nodes 102a-102e may communicate amongst each other with the results of the executions of their respective self-executing codes, for example, to arrive at a consensus on the results. In some implementations, one or a few of the compute nodes 102a-102e may have self-executing codes that self-execute, and the results can be transmitted to the rest of the compute nodes 102a-102e for confirmation.

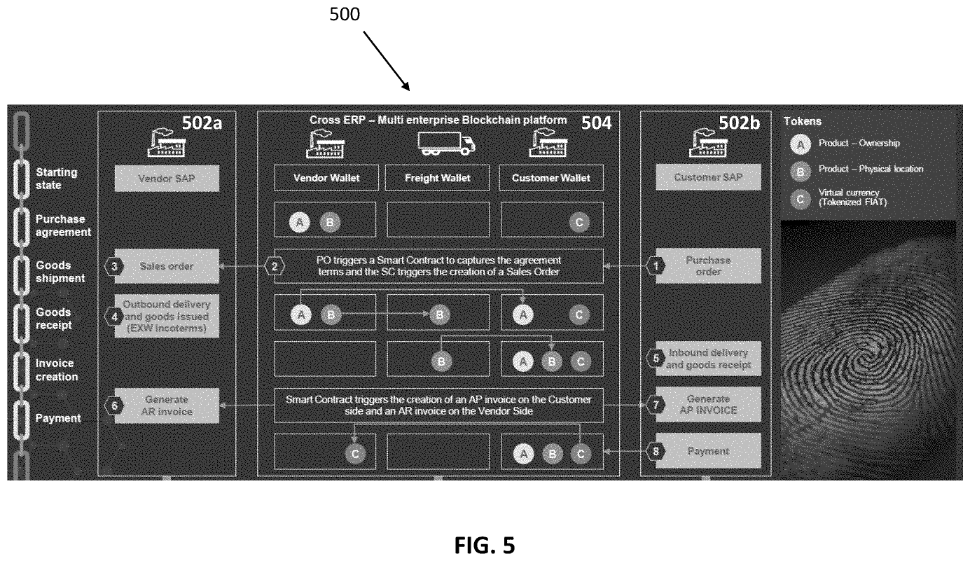

In some embodiments, a self-executing code or a smart contract can facilitate the execution of transactions on the DLN 100 by streamlining the exchange of communications (e.g., purchase and sales orders, etc.) between transacting parties. For example, as discussed below in more details with reference to FIG. 5, the client 109b (e.g., buyer) may generate, via the EPR system 107b, a purchase order to be submitted to the client 109a (e.g., seller). In such instance, the purchase order may be transmitted initially to the smart contract of the DLN 100 via the EPR adapter 105. The smart contract, upon receiving the purchase order, may process the order to capture or extract the terms of the order and generate a sales order, which may then be sent to the client 109a, facilitating the execution of the transaction between the transacting parties.

In some embodiments, the DLN 100 may be linked to one or more compute device(s) such as oracles (not shown) or compute devices providing data feeds that provide external data to the DLN 100. In some implementations, as discussed above, self-executing codes or smart contracts can automatically execute upon realization of some conditions of a transaction, and the oracles may provide the data that can be used to evaluate whether the conditions are met. For example, a transaction may be contingent on the price of a stock, a weather condition, etc., and an oracle may provide the requisite information to the smart contract facilitating the transaction. The smart contract, upon receiving the information, may self-execute after determining that the condition for the transaction has been fulfilled. With reference to the above example, the transaction between clients 109a, 109b may be dependent on a weather condition, and the smart contract may process the purchase order only when the oracle has received the weather information and the condition is fulfilled.

In some embodiments, at least a substantial number of the compute nodes 102a-102e (e.g., at least greater than 50%, 60%, 75%, 90 %, including values and subranges therebetween, of the total number of compute nodes 102a-102e that make up the ZKP-enabled DLN 100) include copies of a distributed ledger 104a-104e onto which transactions that occur on the network are recorded. In some implementations, the recording of the transactions on the distributed ledger 104a-104e may occur when some substantial number of the compute nodes 102a-102e, or a subset thereof, agree on the validity of the transactions. The distributed ledger 104a-104e can be immutable or nearly immutable in the sense that to alter the distributed ledger 104a-104e, at least this substantial number of the compute nodes 102a-102e would have to agree, which can be increasingly difficult when the number of compute nodes 102a-102e is large (and the distributed ledger 104a-104e gets longer). In some implementations, the recording of the transactions on the distributed ledger 104a-104e may occur when a central authority (e.g., the parent organization including the transacting parties (e.g., clients 109a, 109b) as its subsidiaries or constituent units).

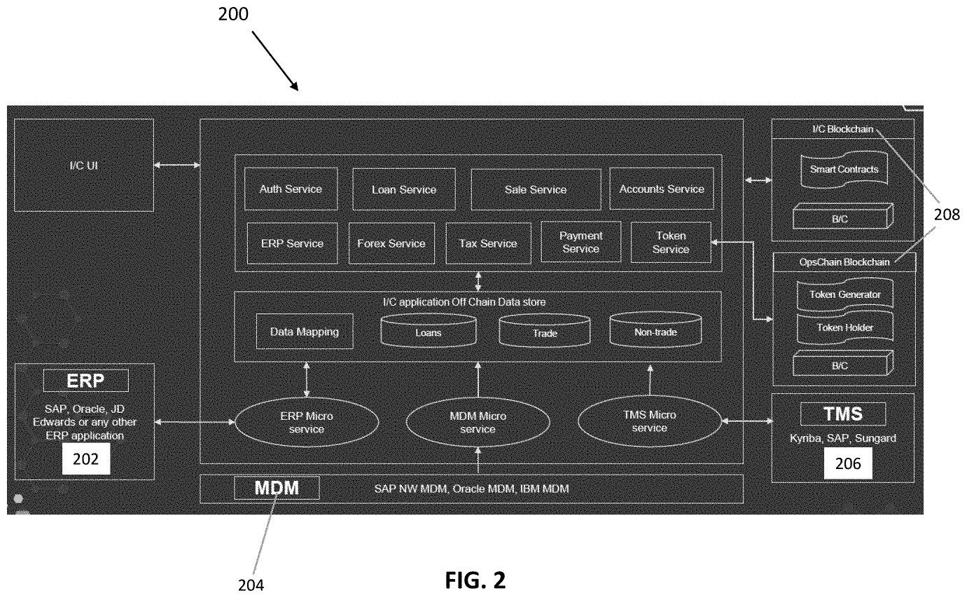

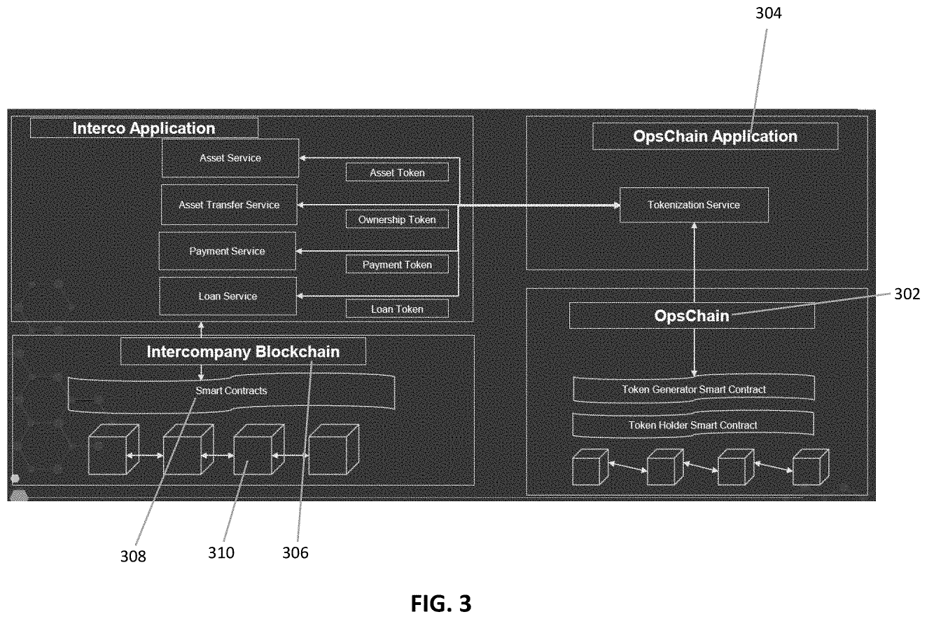

In some embodiments, as discussed above, organizations use so-called enterprise resource planning (ERP) systems to manage operations and resources of their businesses and further automate various functions of the organizations. In some implementations, organizations may also use additional management systems such as a master data module (MDM), treasury management system (TMS), and/or the like. MDMs can be used to manage a master data of an organization, i.e., information about the organization's business shared across the organization, such that the so-called single version of the truth (SVOT) as it relates to the master data emerges. In some implementations, TMS can be used to manage, among other things, the financial operations of the organizations, such as but not limited to managing cash flow in real time, etc. In some embodiments, MDMs, and/or TMS can also be integrated, along with or without an ERP, into a DLN system 101. FIG. 2 shows a schematic block diagram illustrating a DLN system 200 configured to facilitate inter and/or cross-organizational transactions, according to another embodiment. In some embodiments, the DLN system 200 includes an ERP system 202, an MDM 204, a TMS 206 that are collectively engage in a variety of the transactions that include services such as trade transactions, non-trade transactions, loan transactions, and/or the like, which may include authorization services, loan services, sale services, accounts services, ERP services, foreign exchange services, tax services, payment services, token services, etc. In some implementations, the DLN system 200 may include one or more DLNs 208 to aid with the execution of the transactions by facilitating the use of, among other things, smart contract, tokens, accounts, etc. For example, FIG. 3 shows a schematic block diagram illustrating a DLN system to facilitate inter and/or cross-organizational transactions, according to some embodiment. In some embodiments, the DLN system 200 may have, among other things, a smart contract generator and storage system 302 configured to generate and store smart contracts, a token generator 304 configured to generate different types of tokens for use in providing different types of services as part of an inter and/or cross-organizational transaction. For example, as discussed below, a transaction may include trade transaction, non-trade transaction and/or loan transaction involving asset service, asset transfer service, payment service, loan service, etc., between different units of an organization or between different organizations, and the DLN system 200 may facilitate, via the tokenization service component 304, the use of asset tokens, ownership tokens, payment tokens, loan tokens, etc., in executing the transactions. In some implementations, the execution of the transactions may occur on the DLN 306 with the use of smart contracts that facilitate the recording of the transactions on the distributed ledgers 310 of the DLN once the transactions take place.

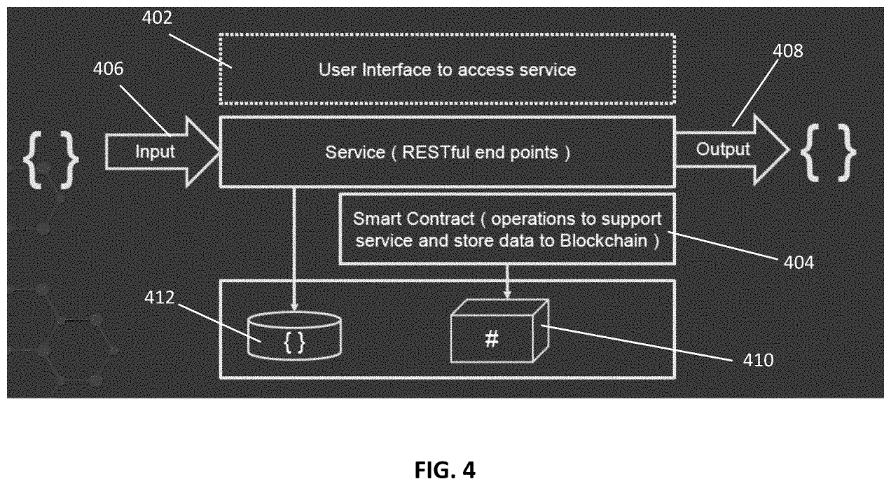

FIG. 4 shows a schematic flow chart illustrating an example application of the DLN system in executing a transaction that includes a service, according to some embodiments. In some embodiments, a user (not shown) may transact with an organization and engage, using a user interface 402, with a transaction system of the organization that includes a DLN system to access a service (e.g., authorization services, loan services, sale services, accounts services, ERP services, foreign exchange services, tax services, payment services, token services, etc.). For example, the user may request for a service that involves one unit of the organization ordering a product from another unit of the organization. That is, the user's transaction with the organization may cause an inter-organization transaction in return. In such instances, the smart contract 404 may be used to facilitate the inter-organizational transaction as discussed in more detail, for example, with reference to FIGS. 5-7. For example, the inter-organizational transaction may include the generation, and submission to the transaction system, of a purchase order 406, and the smart contract may process the purchase order 404 to in turn generate a sales order 408. In some implementations, the inter-organizational transaction may be recorded on the distributed ledgers 410 of the DLN included in the DLN system and/or the transaction system storage 412.

FIG. 5 shows a schematic flow chart illustrating an example use of smart contracts and tokens in a DLN system to facilitate exchange of goods and payment during inter and/or cross-organizational transactions, according to some embodiments. In some embodiments, the trade transaction system 500 may include a DLN 504 bridging the ERP systems 502a, 502b (e.g., ERP system 502a of the vendor or seller, ERP system 502b of the customer or buyer, etc.). In some implementations, the vendor and customer may both be part of the same organization using the trade transaction system 500 for executing transactions (e.g., the vendor and customer may be engaged in inter-organizational transaction). In some implementations, the vendor and customer may be two different organizations engaged in a transaction and using the same trade transaction system 500 (e.g., using the same transaction system employing the trade transaction system 500 and hosted by a third party). In such implementations, the DLN 504 of the trade transaction system 500 may be used to bridge disparate ERP systems (such as ERP system 502a and 502b) as discussed above and as such may facilitate transactions between disparate or different ERP systems (or same or different organizations). The term “disparate or different ERP systems” includes, without limitation, ERP systems produced by different ERP system vendors, ERP systems that have one of more of different transaction execution processes, different messaging systems, different database structures or data storage systems, different input and output fields or formats, different transaction recording and reporting systems or mechanisms, different formats of purchase orders, sales orders, etc., from each other.

In some embodiments, the customer may wish to order a product owned by the vendor, the product represented on the DLN 504 of the transaction system employing the trade transaction system 500 by a pair of tokens, a product ownership token encoding the ownership (e.g., legal) of the product and a product “physical location” or custody token encoding the current state of possession of the product. In general, multiple tokens may represent on the DLN 504 multiple attributes or aspects of the product or asset that is being transacted between the vendor and the customer. For example, a first token may represent the physical custody or location attribute of a product or an asset, a second token may represent the legal custody or ownership attribute of the product or asset, a third token may represent the attribute of interests third parties (other than the vendor or the customer) may have on the asset or product (e.g., lien interest, tax interest, etc.), etc. In some implementations, a token may include information about the asset or product that can be relevant to the respective type of the token. For example, the product ownership token may include information on the person or entity that legally owns the product (e.g., the person or entity that legally has title), and the product custody token may indicate the person or entity that has physical custody of the product at any given time. In some implementations, a crypto-token (e.g., a virtual currency) may be used to represent on the DLN 504 the fiat currency that would be used by the customer to pay for the product. In such implementations, the product ownership token and the product custody or location token may be located in the account or wallet of the vendor at the DLN 504 (e.g., indicating that the vendor has current legal ownership and custody of the product). Further, the crypto-token to be used for the purchase of the product by the customer may be located in the DLN account or wallet of the customer (e.g., indicating that the customer is currently in possession of the crypto-token).

In some embodiments, the customer wishing to purchase the product may generate, using a computing resource of the customer ERP system 502b, a purchase order for the product and transmit the purchase order to the smart contract via a ERP adapter (such as the ERP adapter 105). Upon receiving the purchase order, in some implementations, the smart contract may obtain the terms of the purchase order and generate or cause the generation of a sales order for the product. For example, the smart contract may capture or extract from the purchase order the exchange rate to be applied for the transaction if the transaction involves more than one type of currency. As another example, the smart contract may capture or extract purchase order terms such as but not limited to quantity, account to be charged, shipping addresses, etc., and generate, trigger or otherwise cause the generation of (by the ERP system of the customer, for example) a sales order for the product using the terms or information obtained from the purchase order. In some implementations, the smart contract may then transmit the sale order to the vendor ERP system 502a, via a ERP adapter (such as the ERP adapter 105), for example.

In some embodiments, upon receiving the sales order, the vendor, using a computing resource of the vendor ERP system 502a, may initiate the delivery of the ordered physical product. For example, the physical product may be placed on a freight system (e.g., delivered to a shipping company) for delivery to the customer. In some implementations, the vendor, using a computing resource of the vendor ERP system 502a and via an ERP adapter (e.g., ERP adapter 105) may inform the smart contract that the physical product is on its way to the customer. In some implementations, the smart contract may receive the information from other sources, such as the shipping company or entity that is transporting the product. In such instance, the smart contract may trigger or cause the transfer of the product ownership token (i.e., the token representing ownership attribute of the product or asset being transacted) from the DLN account or wallet of the vendor to the DLN account or wallet of the customer. Further, the smart contract may trigger or cause the transfer of the product custody token to a DLN account or wallet of the shipping entity or company. In some implementations, the product may be passed on between multiple shipping entities (all of which have accounts or wallets on the DLN 504), and the smart contract may transfer the product location or custody token from the DLN account of a shipping entity that passes on the product to the DLN account of the shipping entity that receives the product as the smart contract is notified by the sending and/or receiving entity about the location or custody of the product. Upon receiving confirmation that the physical product has been delivered to or received by the customer (e.g., confirmation provided by the shipping entity and/or the customer), in some implementations, the smart contract may transfer the product custody token from the DLN account or wallet of the shipping entity or company to that of the customer. Further, the smart contract may communicate with the vendor ERP system 502a and/or the customer ERP system 502b to trigger or cause the generation of an accounts receivable invoice and an accounts payable invoice, respectively. In addition, the smart contract may trigger or cause the transfer of the crypto-token from the DLN account or wallet of the customer to that of the vendor. In some implementations, the ERP system of each transaction participant may then record details of the transaction in its own accounting journal. For example, the vendor ERP system 502a may record the receipt of the crypto-token as payment for the shipped product or asset while the customer ERP system 502b may record the addition into the customer DLN account or wallet of the tokens representing the legal ownership attribute, the physical location or custody attribute, etc., of the product or asset. Accordingly, a transaction system that has the trade transaction system 500 can facilitate transaction between organizational units (e.g., two organizations or parts of organizations) by using the capabilities of a DLN such as but not limited to smart contracts, tokens, etc., to manage the generation of sales orders, accounts payable invoices, account receivable invoices, etc. Further, such capabilities allow for the representation of the transaction on the DLN 504, including transfer of payments on the DLN 504.

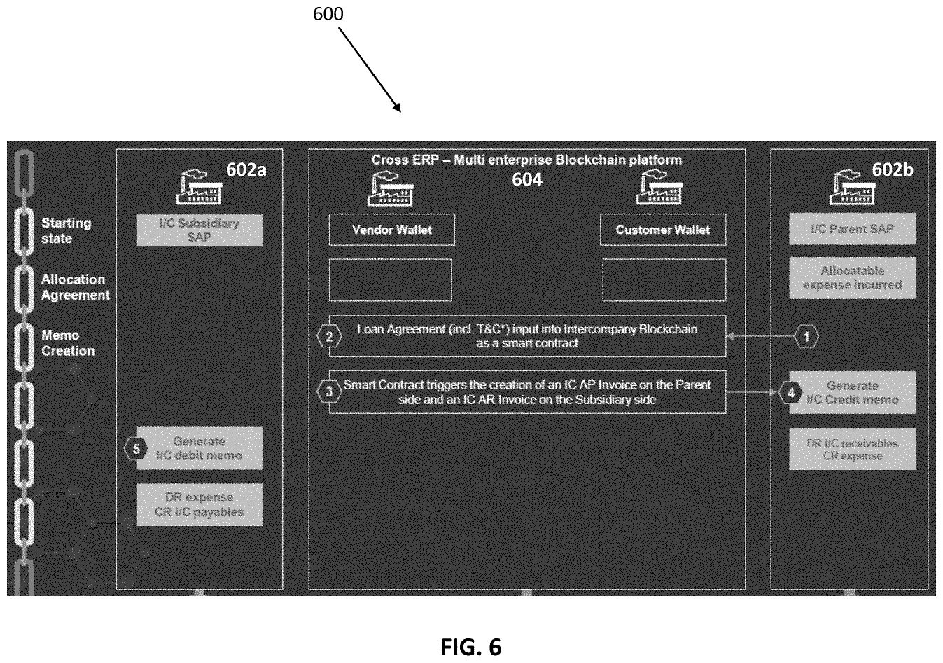

In some embodiments, the disclosed DLN system may be used for transactions that may not involve the sale/movement of inventory and payments, e.g., for non-trade transactions (e.g., inter and/or cross-organizational transactions) that involve the shifting of obligations. For example, in some embodiments, FIG. 6 shows a schematic flow chart illustrating an example use of smart contracts in an expense shifting system to facilitate the shifting of obligations during an inter-organizational transaction. The expense shifting system includes a DLN 604 bridging the ERP system 602b of a parent enterprise to the ERP system 602b of its subsidiary enterprise. In some implementations, a subsidiary enterprise of a parent enterprise may incur an expense and the parent enterprise may be obligated to pay for the expense (e.g., reimburse the subsidiary or shift the expense from the balance book of the subsidiary enterprise to that of the parent enterprise). In such instance, the parent enterprise may generate and submit to the DLN 604 of the expense shifting system 600 an instrument of obligation such as a loan agreement that shifts the expense from the subsidiary enterprise to the parent enterprise. In some implementations, the instrument of obligation (e.g., the loan agreement) may be submitted to the DLN 604 of the expense shifting system 600 via ERP system 602b of a parent enterprise so that the loan agreement is coded as a smart contract on the DLN of the expense shifting system 600. For example, the loan agreement may be submitted to the smart contract service component of the expense shifting system 600 (similar to the smart contract service component 302) so that a smart contract configured to enforce the loan agreement on the DLN 604 may be generated based on the terms and conditions of the loan agreement. In some implementations, upon fulfillment of a triggering condition (e.g., a deadline passing, etc.), the smart contract may proceed with executing the terms of the instrument of obligation, such as trigger or cause the generation of an accounts payable invoice (to be generated by the parent enterprise) and an accounts receivable invoice (to be generated by the subsidiary enterprise). For example, the smart contract may communicate with the ERP system 602a of the subsidiary enterprise and/or the ERP system 602b of the parent enterprise to trigger or cause the generation of an accounts receivable invoice and an accounts payable invoice, respectively. Accordingly, a transaction system that has the DLN 604 bridging the ERP system 602b of a parent enterprise to the ERP system 602b of its subsidiary enterprise can facilitate transaction between organizational units (e.g., a subsidiary enterprise and its parent enterprise) by using the capabilities of a DLN (e.g., the smart contract) to manage the shifting of obligations (e.g., expenses) between the organizational units or enterprises.

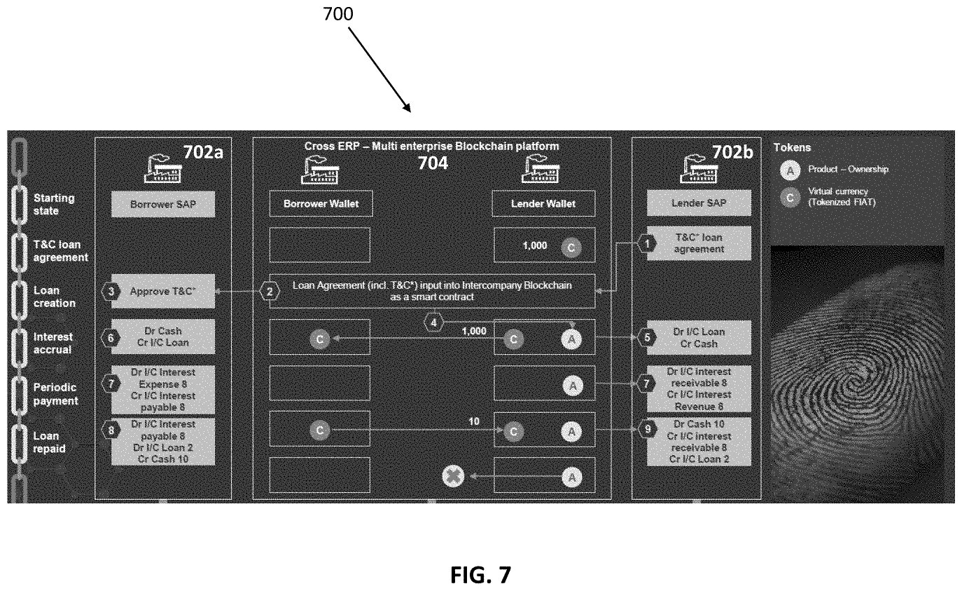

In some embodiments, the DLN system may also be used to execute instruments of obligation generated as part of transactions. For example, FIG. 7 shows a schematic flow chart illustrating an example use of smart contracts and tokens in a DLN system to facilitate execution of instruments of obligations during inter and/or cross-organizational transactions, according to some embodiments. In some embodiments, the loan transaction system 700 may include a DLN 704 bridging ERP systems 702a, 702b (e.g., ERP system 702a of a borrower enterprise, ERP system 702b of a lender enterprise, etc.). In some implementations, the borrower and lender may both be part of the same organization using the loan transaction system 700 for executing a loan transaction. In some other implementations, the borrower and lender may be two different organizations engaged in the loan transaction and using the same loan transaction system 700 (e.g., using the same transaction system employing the loan transaction system 700 and hosted by a third party).

In some embodiments, the borrower enterprise may wish to borrow money from the lender enterprise (e.g., bank), and the fiat currency to be borrowed by the borrower enterprise may be represented on the DLN account or wallet of the DLN 704 of the loan transaction system 700 by a crypto-token (e.g., a virtual currency). In such implementations, the crypto-token may be located in the DLN account or wallet of the lender enterprise (e.g., indicating that the lender enterprise is currently in possession of the crypto-token). In some implementations, the lending or borrowing may be according to a master loan schedule. In some embodiments, upon receiving a request for a loan from the borrower enterprise (e.g., based on the master loan schedule), the lender may generate, using a computing resource of the ERP system 702b of the lender enterprise, an instrument of obligation such as a loan agreement and transmit the instrument of obligation (e.g., the loan agreement) to the DLN 704 of the loan transaction system 700 so that the loan agreement is coded as a smart contract on the DLN 704 of the DLN system 700. For example, the loan agreement may be submitted to the smart contract service component of the DLN system 700 (similar to the smart contract service component 302) so that a smart contract configured to enforce the loan agreement on the DLN 704 may be generated based on the terms and conditions of the loan agreement. In some implementations, upon fulfillment of a triggering condition (e.g., the approval of the instrument of the obligation by both the lender enterprise and the borrower enterprise, etc.), the smart contract may proceed with executing the terms of the instrument of obligation, such as the transfer of the crypto-token located in the DLN account or wallet of the lender enterprise to the DLN account or wallet of the borrower enterprise. Further, the smart contract may transfer, from the DLN account or wallet of the borrower to that of the lender, a product ownership token representing a product that is being used as collateral for the obligation. In addition, the smart contract may also trigger or cause the generation of borrower expense and lender revenue notes per the terms of the agreement. For example, the smart contract may communicate with the ERP system 702a of the borrower enterprise and/or the ERP system 702b of the lender enterprise (e.g., via an ERP adapter such EPR adapter 105) to trigger or cause the generation of the expense note and the revenue note, respectively. In some embodiments, at the end of the duration of the instrument of obligation and per the terms of the loan agreement, the smart contract may transfer (i) crypto-tokens (e.g., in the amount of the principal plus incurred interest) from the DLN account or wallet of the borrower enterprise back to the DLN account or wallet of the lender enterprise and (ii) the product ownership token from the DLN account or wallet of the lender enterprise back to the DLN account or wallet of the borrower enterprise. In some implementations, the execution of the terms of the instrument of obligation such as but not limited to the transfers of the crypto-tokens, the transfer of the product ownership tokens, the generation of the borrower expense and lender revenue notes, etc., may occur or be triggered or caused by the smart contract without any input from either the ERP system 702a borrower enterprise or the ERP system 702b lender enterprise. That is, once the smart contract is generated, the smart contract may execute the terms of the instrument of obligation as discussed above automatically and/or without input from the ERP system 702a of the borrower enterprise or the ERP system 702b of the lender enterprise. After execution of the instrument of obligation, in some implementations, the aforementioned master loan schedule may be updated to reflect that the loan transaction represented by the instrument of obligation has been executed.

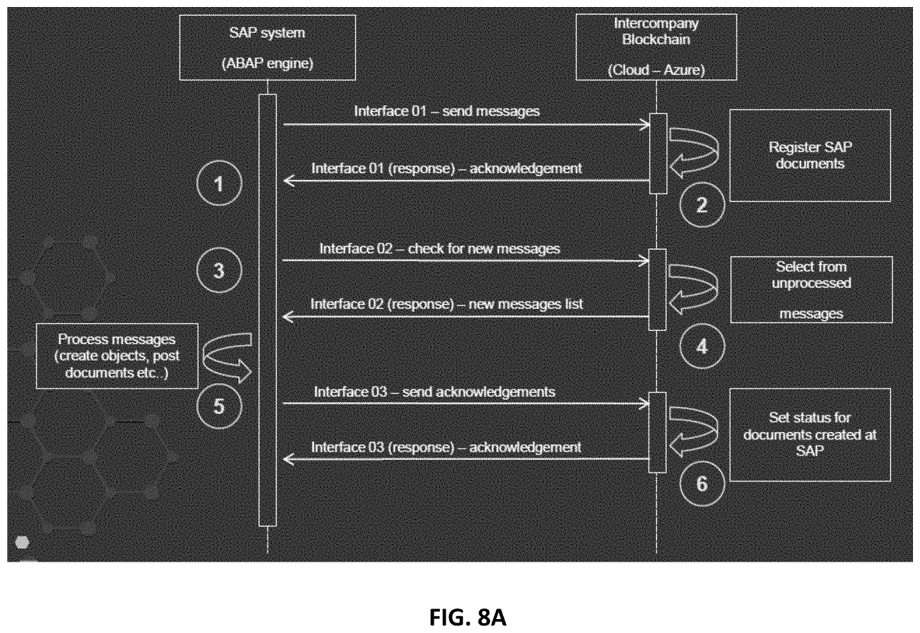

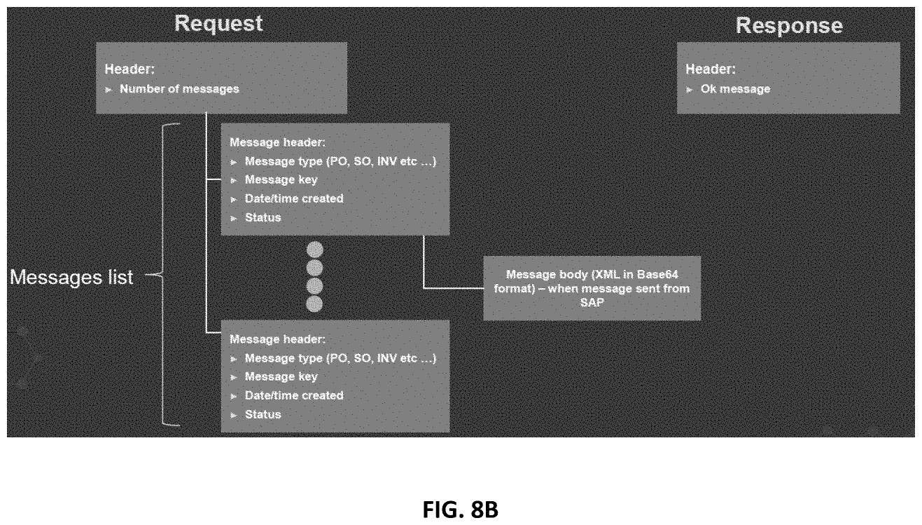

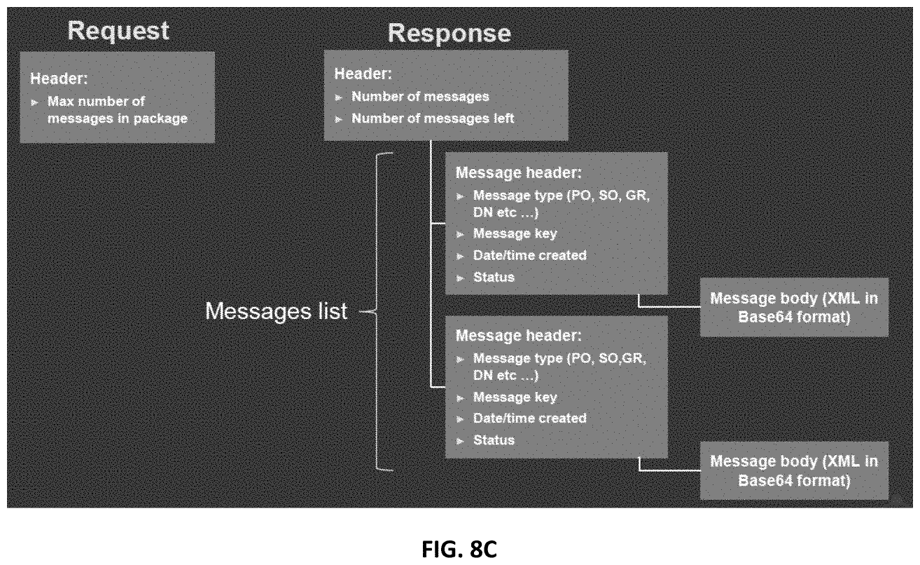

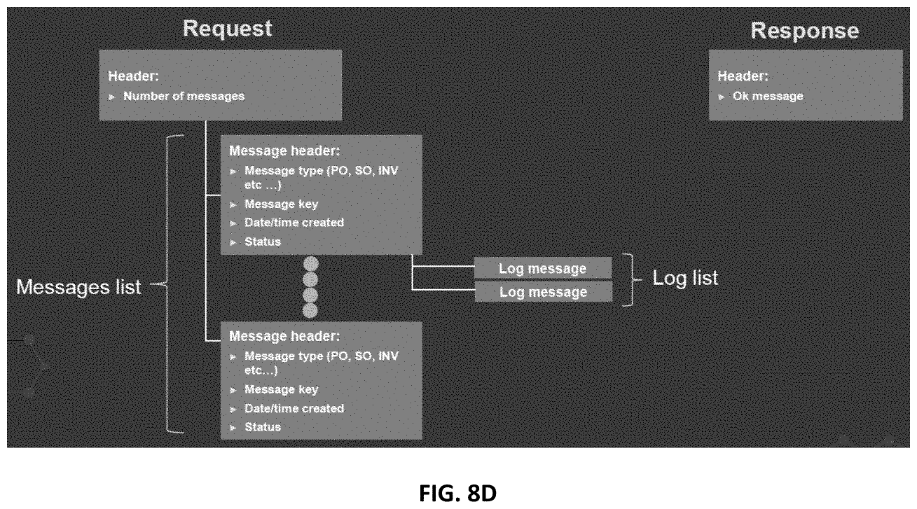

In some embodiments, as discussed above, communications between ERP systems and a DLN (e.g., a smart contract on the DLN) may occur with the aid of an ERP adapter and an ERP connector (e.g., such as the ERP adapter 105 and the ERP connectors 115a, 115b, respectively, shown in FIG. 1). In some implementations, communications may be initiated at ERP systems (i.e., an ERP connector). In some implementations, communications may not be initiated at the DLN or the ERP adapters. For example, when there is a communication (e.g., data, messages, etc.) to be transferred to an ERP system, the communication may be initiated at the ERP system and transferred to the DLN via a pull call from the ERP system to the DLN. In some implementations, the communication system may be a two-way communication system, and both the ERP system and the DLN may be configured to initiate communications. In some embodiments, FIGS. 8A-D show a schematic flow chart (FIG. 8A) and schematic block diagrams (FIGS. 8B-8D) illustrating a communication systems between EPR systems of organizations and a DLN system during inter and/or cross-organizational transactions, where communications are initiated at the ERP system (e.g., and not at the DLN or at the ERP adapter)). In some implementations, for each message transmitted between an ERP system (i.e., an ERP connector) and a DLN system (i.e., via an ERP adapter), there may be a defined unique key to block duplicate processing at the ERP system. Further, the ERP system may include a tool configured to reprocess messages in case if errors. For example, the tool may cancel messages or data that are in error and send information back to the DLN if reprocessing the messages/data is not feasible. In some implementations, the DLN may be configured, upon receiving information about messages/data that are in error, to change the messages/data and resend to the ERP system. FIGS. 8B-8D show example messages between the DLN system and the ERP system, in some embodiments.

While various embodiments have been described and illustrated herein, one will readily envision a variety of other means and/or structures for performing the function and/or obtaining the results and/or one or more of the advantages described herein, and each of such variations and/or modifications is deemed to be within the scope of the embodiments described herein. More generally, one will readily appreciate that all parameters, dimensions, materials, and configurations described herein are meant to be exemplary and that the actual parameters, dimensions, materials, and/or configurations will depend upon the specific application or applications for which the teachings is/are used. One will recognize, or be able to ascertain using no more than routine experimentation, many equivalents to the specific embodiments described herein. It is, therefore, to be understood that the foregoing embodiments are presented by way of example only and that, within the scope of the disclosure, including the appended claims and equivalents thereto, disclosed embodiments may be practiced otherwise than as specifically described and claimed. Embodiments of the present disclosure are directed to each individual feature, system, tool, element, component, and/or method described herein. In addition, any combination of two or more such features, systems, articles, elements, components, and/or methods, if such features, systems, articles, elements, components, and/or methods are not mutually inconsistent, is included within the scope of the present disclosure.

The above-described embodiments can be implemented in any of numerous ways. For example, embodiments may be implemented using hardware, software or a combination thereof. When implemented in software, the software code can be stored (e.g., on non-transitory memory) and executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, netbook computer, or a tablet computer. Additionally, a computer may be embedded in a device not generally regarded as a computer but with suitable processing capabilities, including a smart phone, smart device, or any other suitable portable or fixed electronic device.

Also, a computer can have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer can receive input information through speech recognition or in other audible format.

Such computers can be interconnected by one or more networks in any suitable form, including a local area network or a wide area network, such as an enterprise network, and intelligent network (IN) or the Internet. Such networks can be based on any suitable technology and can operate according to any suitable protocol and can include wireless networks, wired networks or fiber optic networks.

The various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine.

In this respect, various disclosed concepts can be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but can be distributed in a modular fashion amongst a number of different computers or processors to implement various aspects of the disclosure.

Computer-executable instructions can be in many forms, such as program modules, executed by one or more computers or other devices. Generally, program modules include routines, programs, objects, components, data structures, etc. that perform particular tasks or implement particular abstract data types. Typically the functionality of the program modules can be combined or distributed as desired in various embodiments.

Also, data structures can be stored in computer-readable media in any suitable form. For simplicity of illustration, data structures may be shown to have fields that are related through location in the data structure. Such relationships can likewise be achieved by assigning storage for the fields with locations in a computer-readable medium that convey relationship between the fields. However, any suitable mechanism can be used to establish a relationship between information in fields of a data structure, including through the use of pointers, tags or other mechanisms that establish relationship between data elements.

Also, various concepts can be embodied as one or more methods, of which an example has been provided. The acts performed as part of the method may be ordered in any suitable way. Accordingly, embodiments can be constructed in which acts are performed in an order different than illustrated, which can include performing some acts simultaneously, even though shown as sequential acts in illustrative embodiments. All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of ” “Consisting essentially of,” when used in claims, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

All transitional phrases such as “comprising,” “including,” “carrying,” “having,” “containing,” “involving,” “holding,” “composed of,” and the like are to be understood to be open-ended, i.e. , to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
bridging an enterprise resource planning (ERP) system of a buyer enterprise to an ERP system of a seller enterprise that is different from the ERP system of the buyer enterprise, the bridging including:
receiving, at a compute node of a distributed-ledger based network (DLN) and from the ERP system of the buyer enterprise, a purchase order to purchase a product from the seller enterprise based on a purchase agreement between the buyer enterprise and the seller enterprise;
extracting, via the compute node and from the purchase agreement, terms of the purchase agreement to trigger the ERP system of the seller enterprise to generate a sales order based on the extracted terms of the purchase agreement; and
triggering, via the compute node, generation of an accounts payable invoice at the ERP system of the buyer enterprise and generation of an accounts receivable invoice at the ERP system of the seller enterprise in response to approval by the seller enterprise of the sales order and/or confirmation by the buyer enterprise of delivery of the product to the buyer enterprise;
transferring, via the compute node and in response to the approval by the seller enterprise of the sales order, a token from a seller account on the DLN of the seller enterprise to a first account on the DLN, the token representing on the DLN an attribute of the product; and
confirming, via the compute node, settlement of the purchase order after (1) the transferring of the token and/or the triggering of the generation of the accounts payable invoice and (2) the triggering of the generation of the accounts receivable invoice.

2. The method of claim 1, wherein the token representing the attribute of the product is a token representing an ownership attribute of the product, and the first account is a buyer account on the DLN of the buyer enterprise.

3. The method of claim 1, wherein the token representing the attribute of the product is a token representing a physical location attribute of the product, and the first account is a shipper account on the DLN of an intermediate entity tasked with transporting the product to the buyer enterprise.

4. The method of claim 1, wherein the token representing the attribute of the product is the token representing a physical location attribute of the product, and the first account is a shipper account on the DLN of an intermediate entity tasked with transporting the product to the buyer enterprise, the method further comprising:
transferring, via the compute device, the token representing the physical location attribute of the product from the shipper account to a buyer account on the DLN of the buyer enterprise after the delivery of the product to the buyer enterprise.

5. The method of claim 1, wherein the settlement of the purchase order is confirmed after a token representing payment for the product is transferred, via the compute node, from a buyer account on the DLN of the buyer enterprise to the seller account.

6. The method of claim 1, wherein the purchase order is not received at the ERP system of the seller enterprise.

7. The method of claim 1, wherein the sales order is generated automatically by the ERP system of the seller enterprise without an input from the seller enterprise, or an agent thereof.

8. The method of claim 1, wherein the accounts payable invoice is generated automatically at the ERP system of the buyer enterprise without an input from the buyer enterprise, or an agent thereof.

9. The method of claim 1, wherein the accounts receivable invoice is generated automatically at the ERP system of the seller enterprise without an input from the seller enterprise, or an agent thereof.

10. A method, comprising:
bridging an enterprise resource planning (ERP) system of a parent enterprise to an ERP system of a subsidiary enterprise that is different from the ERP system of the parent enterprise, the bridging including:
receiving, at a compute node of a distributed-ledger based network (DLN) and from the ERP system of the parent enterprise, an indication of incurrence of an expense by the parent enterprise to be allocated to the subsidiary enterprise;
extracting, via the compute node and from a master services agreement governing allocation to the subsidiary enterprise of the expense incurred by the parent enterprise, terms and conditions of the master services agreement; and
triggering, via the compute node, generation of:
(1) an accounts receivable invoice at the ERP system of the parent enterprise; and
(2) an accounts payable invoice at the ERP system of the subsidiary enterprise indicating a portion of the expense to be allocated to the subsidiary enterprise,
the triggering caused by a self-executing code segment executing on the DLN and generated based on the terms and conditions of the master services agreement; and
generating, via the compute node, a confirmation confirming allocation of the portion of the expense to the subsidiary enterprise after the triggering of the generation of the accounts payable invoice and the accounts receivable invoice.

11. The method of claim 10, wherein the generation of the accounts payable invoice occurs after the self-executing code segment is approved by the subsidiary enterprise.

12. The method of claim 10, wherein the accounts payable invoice is generated automatically at the ERP system of the subsidiary enterprise without an input from the subsidiary enterprise, or an agent thereof.

13. The method of claim 10, wherein the accounts receivable invoice is generated automatically at the ERP system of the parent enterprise without an input from the parent enterprise, or an agent thereof.

14. A method, comprising:
bridging an enterprise resource planning (ERP) system of a lender enterprise to an ERP system of a borrower enterprise that is different from the ERP system of the lender enterprise, the bridging including:
receiving, at a compute node of a distributed-ledger based network (DLN) and from the ERP system of the lender enterprise, an indication of a loan to be provided by the lender enterprise to the borrower enterprise based on a loan agreement between the lender enterprise and the borrower enterprise;
extracting, via the compute node and from the loan agreement, terms and conditions of the loan agreement; and
receiving, at the compute node and from the ERP system of the borrower enterprise, approval of the extracted terms and conditions of the loan agreement;
generating, via the compute node and based on the extracted terms and conditions of the loan agreement, a self-executing code segment to be executed on the DLN, the self-executing code segment configured to:
(1) generate a token representing ownership attribute of the loan on the DLN; and
(2) deposit the token into a lender account on the DLN of the lender enterprise; and
generating, via the compute node and in response to the deposit of the token into the lender account, a confirmation confirming disbursement of the loan from the lender enterprise to the borrower enterprise.

15. The method of claim 14, wherein the token representing the ownership attribute of the loan is a first token,
the self-executing code segment further configured to transfer a second token representing an amount of the loan from the lender account on the DLN of the lender enterprise to a borrower account on the DLN of the borrower enterprise.

16. The method of claim 14, wherein the token representing the ownership attribute of the loan is a first token,
the self-executing code segment further configured to transfer a second token representing an amount of the loan from the lender account on the DLN of the lender enterprise to a borrower account on the DLN of the borrower enterprise, the transferring of the second token occurring without an input from the lender enterprise.

17. The method of claim 14, wherein the token representing the ownership attribute of the loan is a first token,
the self-executing code segment further configured to transfer a second token representing an amount of interest to be paid on the loan from the borrower account on the DLN of the borrower enterprise to the lender account on the DLN of the lender enterprise.

18. The method of claim 14, wherein the token representing the ownership attribute of the loan is a first token,
the self-executing code segment further configured to transfer a second token representing an amount of interest to be paid on the loan from the borrower account on the DLN of the borrower enterprise to the lender account on the DLN of the lender enterprise, the transferring of the second token occurring without an input from the lender enterprise or the borrower enterprise.

19. The method of claim 14, wherein the self-executing code segment is further configured to annul the token in response to an indication that the lender enterprise no longer owns the loan.

20. The method of claim 14, wherein the generating the confirmation confirming disbursement of the loan occurs without the smart contract receiving an input from the ERP system of the lender enterprise or the ERP system of the borrower enterprise.
